(19) United States
(12) Patent Application Publication
(10) Pub. No.: US 2024/0103814 A1
(43) Pub. Date: Mar. 28, 2024

(54) LOW-NO CODE DEVELOPMENT OF INTELLIGENT WORKFLOW APPLICATIONS USING SKILL ARTIFACTS

(71) Applicant: SAP SE, Walldorf (DE)

(72) Inventors: Qiu Shi Wang, Singapore (SG); Lin Cao, Singapore (SG)

(21) Appl. No.: 17/951,894

(22) Filed: Sep. 23, 2022

(51) Int. Cl. G06F 8/20

(52) U.S. Cl. CPC G06F 8/24

(57) ABSTRACT

Methods, systems, and computer-readable storage media for integrating skills into computer-executable applications using a low-code/no-code (LCNC) development platform.

### BACKGROUND

Enterprises use software systems to conduct operations. Example software systems can include, without limitation, enterprise resource management (ERP) systems, customer relationship management (CRM) systems, human capital management (HCM) systems, and the like. In some software systems, processes that underly operations of an enterprise are programmatically defined to enable execution of the processes using the software systems. A workflow can be executed using a set of technologies and tools that enable documents, information, activities and tasks to flow appropriately in enterprise or a department of an enterprise.

So-called intelligent workflows can be described as a core technology of enterprise digitalization. Among other features, intelligent workflows can automate manual tasks and integrate artificial intelligence (AI), analytics and automation to improve efficiencies in enterprise operations. However, building intelligent workflows presents numerous challenges. For example, it can require deep experience and relatively high skill level across numerous technical areas including, but not limited to, machine learning (ML), data analytics, full stack development, user interface (UI)/user experience (UX), and the like. That is, highly skilled and experienced developers in multiple disparate technologies are needed to develop applications (during a design-time) that enable users to execute intelligent workflows in production use (during runtime). Further, numerous technical resources need to be provisioned, deployed, and consumed for design-time development of such applications. Even large enterprises, however, often lack such skills and resources to build intelligent workflows, presenting a significant obstacle for enterprise digitalization.

### SUMMARY

Implementations of the present disclosure are directed to integration of user skills into application development. More particularly, implementations of the present disclosure are directed to a low-code/no-code (LCNC) development platform for integration of intelligent workflow skills into applications using drag-drop functionality.

In some implementations, actions include receiving, during a design-time and by an application development platform, user input representative of a skill for invocation during runtime execution of an application, the skill being associated with a skill artifact that is stored in a library of skill artifacts, providing, by the application development platform, the application as computer-executable code including a code snippet that is selectively executable to invoke the skill during runtime execution of the application, and during runtime execution of the application, receiving, by an application runtime, user input representative of invocation of the skill, and in response, retrieving, by a skill runtime that communicates with the application runtime, the skill artifact associated with the skill, transmitting, by the skill runtime, a request to a service for execution of the skill, the request including input data including one or more of data input by a user during runtime execution of the application and data provided in the skill artifact, receiving, by the skill runtime, a response from the service, and providing, by the skill runtime and to the application runtime, the response to display at least a portion of the response to the user. Other implementations of this aspect include corresponding systems, apparatus, and computer programs, configured to perform the actions of the methods, encoded on computer storage devices.

These and other implementations can each optionally include one or more of the following features: the skill artifact defines a set of inputs representing the input data, the input data being required to execute functionality of the skill by the service, and a set of outputs representing output data that is to be provided by the service in the response; the response received from the service includes a data object storing data determined during execution of functionality of the skill by the service; the user input representative of a skill for invocation during runtime execution of an application includes a drag-and-drop input to a graphical representation of the skill provided by the application development platform; actions further include parsing, by the skill runtime, at least a portion of the skill artifact to generate the request; the request is transmitted by the skill runtime to the service through an application programming interface (API) of the service; and the application runtime and the skill runtime communicate through a hypertext transfer protocol (HTTP) connection.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example architecture in accordance with implementations of the present disclosure.

FIG. 3 depicts an example user interface (UI) flow in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to integration of user skills into application development. More particularly, implementations of the present disclosure are directed to a low-code/no-code (LCNC) development platform for integration of intelligent workflow skills into applications using drag-drop functionality. In some implementations, actions include receiving, during a design-time and by an application development platform, user input representative of a skill for invocation during runtime execution of an application, the skill being associated with a skill artifact that is stored in a library of skill artifacts, providing, by the application development platform, the application as computer-executable code including a code snippet that is selectively executable to invoke the skill during runtime execution of the application, and during runtime execution of the application, receiving, by an application runtime, user input representative of invocation of the skill, and in response, retrieving, by a skill runtime that communicates with the application runtime, the skill artifact associated with the skill, transmitting, by the skill runtime, a request to a service for execution of the skill, the request including input data including one or more of data input by a user during runtime execution of the application and data provided in the skill artifact, receiving, by the skill runtime, a response from the service, and providing, by the skill runtime and to the application runtime, the response to display at least a portion of the response to the user.

As used herein, the terms low-code and no-code generally refer to software development platforms and/or tools that are targeted at users with little or no development experience (e.g., referred to as citizen developers, or low-code (no-code) developers). Another target of such platforms and/or tools can include more experienced developers having shorter timeframes for development (e.g., low-code (no-code) enabling developers to develop more quickly). Here, low-code can refer to development requiring some level of coding experience, while no-code can refer to development with no coding experience. In the context of implementations of the present disclosure, low-code (no-code) extension developers generally refers to developers of extensions to applications, who have limited development experience and/or are under tight timeframes to develop application extensions. While the present disclosure references low-code developers and/or no-code developers, it is appreciated that implementations of the present disclosure can be realized for the benefit of more sophisticated developers and/or developers having more generous timeframes to develop application extensions.

To provide further context for implementations of the present disclosure, and as introduced above, enterprises use software systems to conduct operations. Example software systems can include, without limitation, enterprise resource management (ERP) systems, customer relationship management (CRM) systems, human capital management (HCM) systems, and the like. In some software systems, processes that underly operations of an enterprise are programmatically defined to enable execution of the processes using the software systems. A workflow is a set of technologies and tools that enable documents, information, activities and tasks to flow appropriately in enterprise or a department of an enterprise.

So-called intelligent workflows can be described as a core technology of enterprise digitalization. More particularly, intelligent workflows are executed using digital workplaces and can span multiple applications. In some examples, a digital workplace can be described as a central interface, through which a user (e.g., agent, employee) can access all of the applications required to perform respective tasks of workflows in executing enterprise operations. Among other features, intelligent workflows can automate manual tasks and integrate artificial intelligence (AI), analytics and automation to improve efficiencies in enterprise operations.

However, building intelligent workflows presents numerous challenges. For example, it can require deep experience and relatively high skill level across numerous technical areas including, but not limited to, machine learning (ML), data analytics, full stack development, user interface (UI)/user experience (UX), and the like. That is, highly skilled and experienced developers in multiple disparate technologies are needed to develop applications (during a design-time) that enable users to execute intelligent workflows in production use (during runtime). Further, numerous technical resources need to be provisioned, deployed, and consumed for design-time development of such applications. Even large enterprises, however, often lack such skills and resources to build intelligent workflows, presenting a significant obstacle for enterprise digitalization.

To illustrate this, an example intelligent workflow can be considered, which includes a purchase order request and approval intelligent workflow that can be executed by users (e.g., employees, agents of an enterprise) through a digital workplace. This example intelligent workflow is frequently used in procurement processes, and requires full stack developers to, for example, create new data services on the back-end, develop programming logic for request workflow tasks and approval workflow tasks, as well as UI/UX on various front-ends (e.g., computer, mobile). In some instances, this example intelligent workflow also requires ML and data analysis experts to build ML models based on rules and historical data to recommend the specifications of purchasing items to requesters (i.e., users executing purchase request tasks), for example. This example intelligent workflow also requires ML models for approvers (i.e., users executing purchase request approve/deny decisions) to predict the impact approval or rejection of the request will have on enterprise operations.

The example intelligent workflow illustrates the significant demand for skilled developers and technical resources for development poses in enterprise digitalization. This is for a single example, while enterprise digitalization can encompass hundreds, if not thousands of workflows executed by multitudes of disparate applications (e.g., ERP, CRM, HCM). With the evolution of enterprise digitalization, the demand of application development and deployment has expanded exponentially and continues to expand. The need for professional developers with broad skill sets in diverse development technologies presents a bottleneck in the development of enterprise applications.

In view of the above context, implementations of the present disclosure provide an application development and runtime platform that enable LCNC integration of intelligent workflow skills into applications during a design-time and execution of intelligent workflows during a runtime. In some examples, and as described in further detail herein, the application development platform communicates with a library that provides skill artifacts for integration into applications. Each skill artifact is selectable and computer-executable for LCNC integration into an intelligent workflow. For example, skill artifacts can be integrated into an intelligent workflow using drag-drop functionality.

Accordingly, implementations of the present disclosure address demands to streamline application development processes and enable enterprises to acquire development skills to speed up enterprise digitalization and reduce consumption of technical resources in implementing enterprise digitalization. That is, and as described in further detail herein, the application development platform of the present disclosure reduces and/or obviates at least some technical resources that would otherwise be consumed in developing applications that provide functionality for intelligent workflows, as well as increasing the speed of development of such applications for more rapid deployment to production.

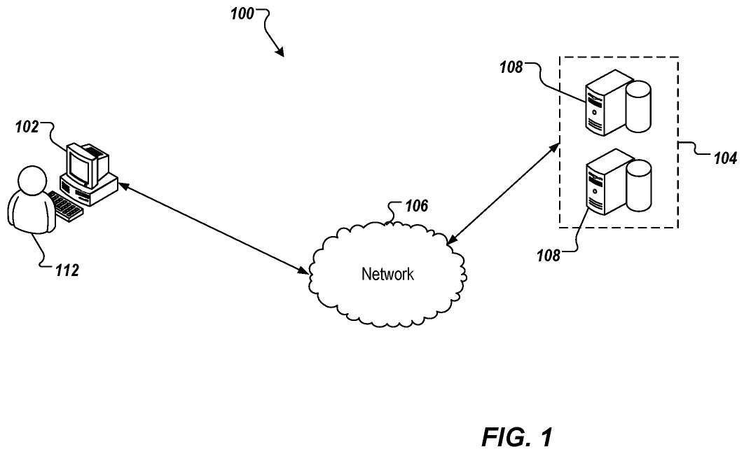

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106). In some examples, the server system 104 can provision a cloud platform that hosts one or more cloud-based applications.

In accordance with implementations of the present disclosure, the server system 104 can host an application development and runtime platform. As described in further detail herein, the application development and runtime platform can be used to develop applications that can be used for execution of intelligent workflows as well as deployment of the applications for production use. For example, the user 112 can be a developer (e.g., LCNC developer) that interacts with the application development and runtime platform to develop an application during design-time. As another example, the user 112 can execute one or more tasks of an intelligent workflow through interaction with the application during runtime.

As described in further detail herein, the application development and runtime platform of the present disclosure enables users to apply skills to application development by drag-and-drop interactions. More particularly, implementations of the present disclosure provide a set of skill artifacts, each skill artifact being user-selectable and computer-executable in application development. In some implementations, the set of skill artifacts includes build skill artifacts, service skill artifacts, workflow skill artifacts, and intelligent skill artifacts. In some examples, fuzzy skills of how to build intelligent workflows are converted into build skill artifacts, which can be described as definable and executable building blocks. In some examples, data models and services provided on back-ends are defined into service skill artifacts, which can be consumed by other skill artifacts (e.g., through restful (REST) and/or open data protocol (OData) application programming interfaces (APIs)). In some examples, workflow skill artifacts define respective tasks of a workflow that are to be executed in response to events and/or conditions (i.e., during runtime). The workflow skill artifacts can be interlinked and interoperated with each other. In some examples, intelligent skill artifacts can encapsulate analytics and ML models used in a workflow. In some examples, intelligent skill artifacts are linked to data targets that are connectable to different data services and to events and/or conditions in a workflow.

In accordance with implementations of the present disclosure, each skill artifact has a respective manifest definition and is computer-executable to perform a task and/or an action (e.g., during design-time, during runtime). In some implementations, each skill artifact can be customized. In some implementations, each skill artifact can be reused (e.g., through industry standard Open API based REST operations/actions). In some examples, skill artifacts can be created by professional developer and published to one or more libraries (e.g., a cloud-based central library). As described in further detail herein, when building an application, a developer (e.g., a no-code developer) can search one or more libraries for relevant skill artifacts, can drag-and-drop skill artifacts into an application studio within which the application is developed, and can configure properties of skill artifacts. In some examples, the developer can link skill artifacts together (e.g., through a UI of the application studio) into an application that can be deployed for production use (e.g., on a cloud platform).

As noted above, skill artifacts have well defined metadata structure. To illustrate this, an example skill artifact (manifest definition) of an intelligent workflow skill is provided in Listing 1, below:

```
“definitions”: {
  “skillId”: “76c6e0e8-9908-44c2-8f53-ad2c280840aa”,
  “name”: “Purchasing Recommendation”,
  “description”: “Skill for Purchasing Recommendation”,
  “inputs”: {
    “Name”: { “$ref”: “#root/component/schema/input/text”
},
    “Content-type”: { “$ref”:
“#root/component/schema/input/content-type” }
  },
  “output”: {
    “Description”: { “$ref”:
“#root/component/schema/input/description” },
    “Price”: { “$ref”:
“#root/component/schema/input/price” },
    “ReviewCount”: { “$ref”:
“#root/component/schema/input/reviewCount” },
    “ReviewScore”: { “$ref”:
“#root/component/schema/input/reviewScore” }
  },
    “common_rest_errors”: {
      “enum”: [
        {
          “code”: 400,
          “description”: “Bad request”,
          “value”: “BadRequestResponse”,
          “type”: “string”
        },
        {
          “code”: 401,
          “description”: “Unauthorized”,
          “value”: “Unauthorized”,
          “type”: “string”
        },
        {
          “code”: 403,
          “description”: “ForbiddenResponse”,
          “value”: “ForbiddenResponse”,
          “type”: “string”
        }
      ]
    },
    “generalResponse”: {
      “type”: “object”,
      “properties”: {
        “responseCode”: {
          “$id”:
“#root/$type/generalResponse/responseCode”,
          “title”: “Responsecode”,
          “type”: “integer”,
          “examples”: [200],
          “default”: 0
        },
        “content-type”: {
          “$id”:
“#root/$type/generalResponse/content-type”,
          “title”: “Content-type”,
          “type”: “string”,
          “default”: “”,
          “examples”: [“”],
          “pattern”: “\hat{ }.*$”
        },
        “content-encoding”: {
          “$id”:
“#root/$type/generalResponse/content-encoding”,
          “title”: “Content-encoding”,
          “type”: “string”,
          “default”: “”,
          “examples”: [“”],
          “pattern”: “\hat{ }.*$”
        },
        “Etag”: {
          “$id”: “#root/$type/generalResponse/Etag”,
          “title”: “Etag”,
          “type”: “string”,
          “default”: “”,
          “examples”: [“”],
          “pattern”: “\hat{ }.*$”
        }
      }
    }
  }
}
```

### Listing 1: Example Skill Artifact (Manifest Definition)

The example of Listing 1 represents an intelligent workflow skill artifact for recommending an item for a purchase order request. The example of Listing 1 is representative of an intelligent skill artifact to query a service (e.g., a service providing a ML model to recommend items for purchase). In the example of Listing 1, inputs of name and content type are provided and outputs of description, price, review count, and review score. In this example, and as described in further detail herein, the purchase recommendation skill can be invoked, which can include receiving user input of name and content type, calling a service that processes the user input to determine description, price, review count, and review score of one or more products as output, and displaying the output to a user.

With reference to the example intelligent workflow introduced above (purchase request and approval) example skill artifacts can be considered. In general, the workflow of the purchase request and approval process includes end-to-end workflow logic. This can include each task that is to be executed, events and/or conditions that a task is to be executed in response to. Each task and associated events/conditions is encapsulated in a workflow skill artifact. Multiple workflow skill artifacts, and thus tasks, can be interlinked for interoperation. For example, output of one or more skill artifacts can be provided as input to one or more other skill artifacts. In some examples, and as noted above, the example intelligent workflow can implement a first ML model to recommend items to be purchase and a second ML model to predict impact of the purchase of an item would have on enterprise operations. In this example, the first ML model is provided in a first intelligent skill artifact and the second ML model is provided in a second intelligent skill artifact. Also in this example, each intelligent skill artifact can indicate data targets from respective data services and REST API(s) pluggable to events and conditions in the workflow. For example, during runtime, a ML model can receive events/conditions through one or more REST APIs, as defined in a respective intelligent skill artifact, and in response, can request and receive input data (target data) from a data service, as defined in a respective intelligent skill artifact. The ML model can process the input data to provide an output (e.g., prediction of one or more items for purchase, a prediction on impact purchase of one or more items may have) that can be used in one or more subsequent tasks of the intelligent workflow.

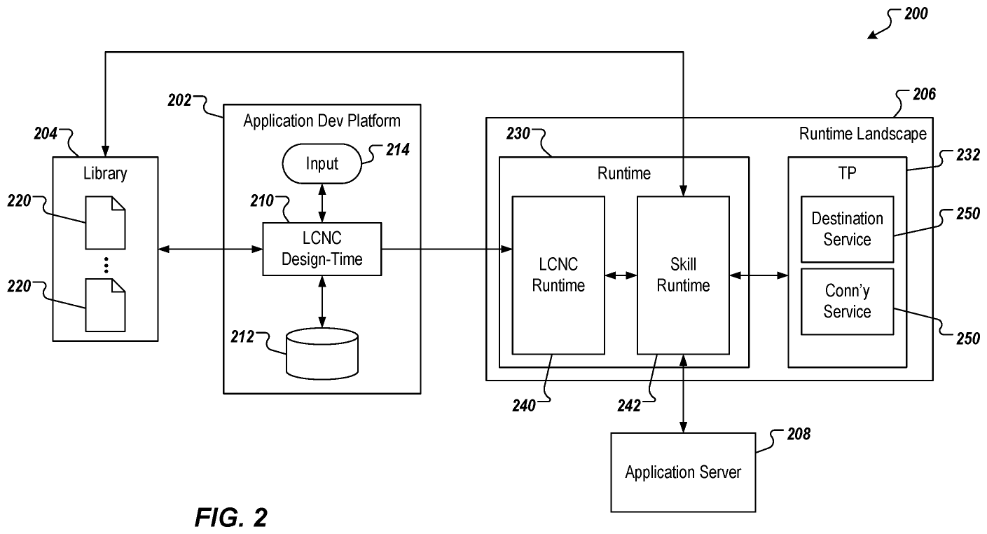

FIG. 2 depicts an example architecture 200 in accordance with implementations of the present disclosure. The example architecture 200 includes an application development platform 202, a library 204, a runtime landscape 206, and an application server 208. In some examples, the application development platform 202, the library 204, and the runtime landscape 206, collectively, at least partially define the application development and runtime platform of the present disclosure. As described in further detail herein, the application development platform 202 enables LCNC development of an application based on one or more skill artifacts retrieved from the library 204, and the application is deployed and executed in the runtime landscape 206 during runtime. In some examples, the application server 208 represents one or more applications servers (e.g., provisioned within a cloud platform), which can host one or more services called during runtime, as described in further detail herein.

In the example of FIG. 2, the application development platform 214 includes a LCNC design-time environment 210 and a data store 212. As described in further detail herein, the LCNC design-time environment 210 receives input 214 for development of the application. For example, the input 214 can include user input provided through one or more UIs. Example user input can include, without limitation, selection of graphical representations of skill artifacts, drag-and-drop interactions, and text. In the example of FIG. 2, the library 204 stores skill artifacts 220, which can be selectively retrieved by the LCNC design-time environment 210 for development of applications. In the example of FIG. 2, the runtime landscape 206 includes a runtime environment 230 and a technology platform (TP) 232. The runtime environment 230 represents a native environment that the application is executed within. Example runtime environments can include, without limitation, iOS, Android, Windows, and Javascript/hypertext mark-up language (HTML) running in a browser. An example technology platform includes, without limitation, SAP Business Technology Platform (BTP), provided by SAP SE of Walldorf, Germany, which can be described as a unified, cloud-based environment that brings together data and analytics, artificial intelligence, application development, automation, and integration. The runtime environment 230 includes a LCNC runtime 240 and a skill runtime 242. The application that is developed using the application development platform 202 is executed within the LCNC runtime 240 and can invoke skills for execution by the skill runtime 242, as described in further detail herein. The TP 232 hosts one or more services 250 (e.g., destination service, connectivity service) that enable requests to be sent to and responses to be received from one or more (external) services (e.g., a product recommendation service) executed on the application server 208.

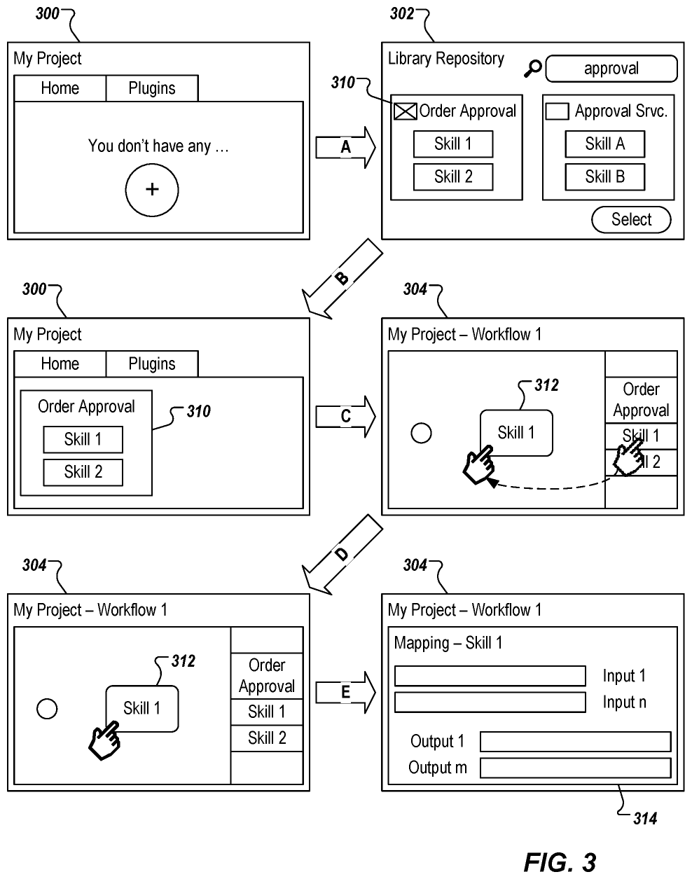

In further detail, the LCNC design-time 210 provides a design-time canvas within the application development platform 202. In some examples, the design-time canvas is provided as one or more UIs, through which user input (e.g., the input 214) is received and output is displayed to users. An example of design-time application development is described in further detail herein with reference to FIG. 3. For deployment, the application developed using the application development platform 202 is provided to the LCNC runtime 240.

In some implementations, the application is provided as computer-executable code (e.g., binary code), which includes code (e.g., code snippets) to invoke one or more skills based on respective skill artifacts 220 during runtime, as described in further detail herein. In some examples, for each skill artifact included in the application, the LCNC runtime 240 converts input data (e.g., received by a user during runtime) to typed input data per the respective artifact manifest. More particularly, and as discussed above with reference to the example of Listing 1, each skill artifact has typed and named input and output parameters. In some examples, name uniquely identifies a parameter within a list of inputs and/or a list of outputs. For each parameter, a type is provided indicating a data type of the parameters. In some examples, data type is used for inputs and outputs of executable skills. Data type information is also used for static type checking at design-time and to provide suggestions and validation when modeling data flow. In some examples, each data type follows the Javascript object notation (JSON) schema. For example, and with reference to Listing 1, above, input parameters include:

Name”: { “$ref”: “#root/component/schema/input/text” },
“Content-type”: { “$ref”:
“#root/component/schema/input/content-type” }
}

### Listing 2: Example Portion of Listing 1

In some examples, during runtime and for each skill artifact, the typed input data is provided to the skill runtime 242 and is used at the time of skill invocation. That is, the typed input data for a skill is used when the skill is to be executed during runtime. During design-time, as a developer drags-and-drops a skill into a canvas (UI), the code snippet to invoke a skill is generated (transparently to the developer). With example reference to Listing 1, which represents an instance of a purchase recommendation skill, input data is provided for binding the user input from an input interface to an array of skill input. Further, for the output, the skill output JSON object is bound to an output interface. For example, and without limitation, the following code snippet can be provided:

//CreateSkill using SkillFactory
Skill skill = SkillFactory.createSkill(skillData, “rest”);
//prepare input data
SkillInput[ ] skillInputs = new SkillInput[ ] {skillInput};
// invoke skill
SkillOutput[ ] skillOutputs = skill.execute(skillInputs,
“Purchasing_Recommendation”, false);

### Listing 3: Example Code Snippet to Invoke Skill

During runtime, a code snippet (e.g., the example code snippet of Listing 3) of the application is executed to invoke a respective skill. For example, an instance of a skill artifact is instantiated in the skill runtime 242 by calling a create skill function (SkillFactory.createSkill). Based on the input data definition in the skill artifact metadata, the skill runtime 242 prepares skill inputs (SkillInput[ ]) and executes skill invocation calls to a skill runtime service. For example, and with reference to the example of Listing 1, the purchasing recommendation skill is invoked.

In some examples, the skill runtime 242 uses the typed input data to execute a respective skill and returns typed output or error data back to the LCNC runtime 240. The LCNC runtime 240 resolves mapping variables before providing input data to the skill runtime 242. The variables in LCNC runtime 240 have specific data types or more complex data structures.

FIG. 3 depicts an example user interface (UI) flow in accordance with implementations of the present disclosure. The example of FIG. 3, the UI flow is representative of UIs displayable to a user in an application development environment for LCNC development of applications (e.g., the application development platform 202 of FIG. 2). In the example of FIG. 3, a general project UI 300, a library UI 302, and a project-specific UI 304 are provided.

In the example of FIG. 3, the general project UI 300 can be initially displayed to a user. For example, the general project UI 300 can be displayed to a user that is interacting with the application development platform 202 of FIG. 2. As depicted in the example of FIG. 3, the general project UI 300 is absent any representations of workflow projects for the user. In some examples, the user can initiate a workflow project to create an intelligent workflow.

In some implementations, the user can provide input representative of a search request to search available tasks and associated skills. The search request can include one or more search terms that can be used to query a library, such as the library 204 of FIG. 2. In the example of FIG. 3, the user can input a search request including the search term “approval” into the library UI 302 during an action A, and, in response, the library UI 302 can display search results. In the example of FIG. 3, the library UI 302 displays a graphical representation 310 of an order approval task, among other search results. In the example of FIG. 3, the user selects the order approval task during an action B, which results in the graphical representation 310 of the order approval task being displayed in the general project UI 300.

In the example of FIG. 3, the user can edit the workflow based on the order approval task. For example, the user can select the order approval task within the general project UI 300 (e.g., double-clicking on the graphical representation 310) during an action C, and, in response, the project-specific UI 304 can be displayed. The user can select a skill for inclusion in the order approval task by, for example, a drag-and-drop interaction on a graphical representation 312 of a skill artifact within the project-specific UI 304 during an action D.

In some examples, the user can configure properties of the skill. For example, the user can select the skill within the project-specific UI 304 (e.g., double-clicking on the graphical representation 312) during an action E, and, in response, a mapping interface 314 can be displayed in the project-specific UI 304. In some examples, the manifest file of the skill (e.g., the example of Listing 1) is read to determine the input/output/error signature and provide mapping fields within the mapping interface 314, through which the user can provide input to define a mapping for the skill. For example, and with reference to the example of Listing 1, the skill can include a product recommendation and the mapping 314 is populated with input fields (e.g., to be displayed in a UI during runtime) to receive input of name and content type and output fields to display output (results) of invocation of the skill. In this example, output can include one or more products and, for each product, description, price, review count, and review score.

In general, a skill artifact can be any appropriate form, such as a wrapper of a backend service, which provides, for example, a data service and an intelligent service (e.g., as provided in the example of Listing 1). In some examples, the skill artifact can be a group of UI controls, which can perform specific actions. For example, a workflow task UI to approve purchase order can be a skill artifact, which the developer can drag-and-drop into a page of an application. In this example, the skill can be invoked to display a group of UI controls to take purchase order identifier (ID), purchase order description, amount, requester, and the like as input data on a page of the application. The skill artifact can also provide functionality for data manipulation, data analytic functionality, connecting and pipelining to other systems in backend, and the like.

In some implementations, the application development platform 202 provides, as output, computer-executable code (binary code) in any appropriate programming language, which code is executable during runtime to invoke on or more skills. For example, and without limitation, the code can be executed to provide a UI control to provide a purchase order approve skill during runtime. The UI control can be provided using one of a set of executable binary code, such that the UI control is native to a runtime environment. For example, the example of Listing 1 can be a service implemented in Java or Node.JS (Javascript) running on a cloud platform. In general, the application can be composed by multiple skill artifacts and target for multi-platforms.

Referring again to FIG. 2, during runtime, the skill runtime 242 can execute skill artifacts using, for example, wrapping REST operations. In some examples, a skill artifact is invoked by the LCNC runtime 240. For example, the LCNC runtime injects a hypertext transfer protocol (HTTP) connection to invoke a skill from the skill runtime using a REST operation. In some implementations, the skill runtime 242 fetches a skill artifact 220 (skill artifact manifest) from the library 204 for a respective skill that is invoked. The skill runtime 242 parses the skill metadata within the skill artifact (e.g., using a JSON parser). In some examples, static values in skill metadata are determined, the static values having been provided during design-time. For example, and with reference to Listing 1, input values, output values, and error values are provided at design-time. The static values are read by the parser of the skill runtime 242.

In some implementations, the skill runtime 242 resolves binding details for skill operations. Example binding details can include, without limitation, service protocol and service location. For example, and with reference to Listing 1, the parsed input binding details of product category and reason of purchase are resolved. Using the resolved information, the skill runtime 242 executes skill invocation calls to a respective service hosted by the application server 208. In some examples, the service is provided as a set of microservices, one or more of which are already created and published by professional developers, to provide various kinds of functionality. For example, and with reference to Listing 1, the service can be a product recommendation service that is invoked. In some examples, the skill runtime 242 outputs a result of the skill invocation, which can be used for one or more (downstream) tasks (e.g., display to a user). For example, and with reference to Listing 1, skill invocation can result in a data object (e.g., JSON object) that contains product review count, review scores, product images, product descriptions, and the like. The result of the skill invocation is resolved and returned to the LCNC runtime 240 (e.g., using HTTP).

In some examples, the skill runtime 242 has a backing service, that provides wrappers to backend services through the destination 250 and the connectivity service 250 of the TP 232. In some examples, the backing service provides one or more authorization mechanisms to enable authentication/authorization through the destination service 250 to call next-level (downstream) service (e.g. ERP system, CRM system).

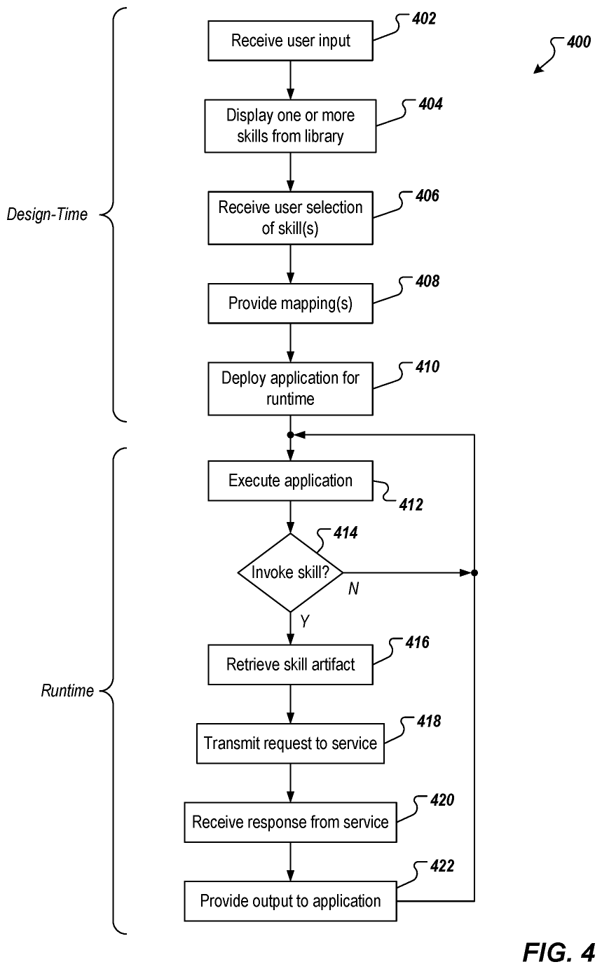

FIG. 4 depicts an example process 400 that can be executed in accordance with implementations of the present disclosure. In some examples, the example process 400 is provided using one or more computer-executable programs executed by one or more computing devices.

User input is received (402). For example, and as described in detail herein with reference to FIG. 2, during design-time of an application, the LCNC design-time environment 210 of the application development platform 202 receives input 214 for development of the application. For example, the input 214 can include user input provided through one or more UIs. Example user input can include, without limitation, selection of graphical representations of skill artifacts, drag-and-drop interactions, and text. In some examples, the input 214 includes a search request can include one or more search terms that can be used to query the library 204 of FIG. 2. One or more skills are displayed (404). For example, and as described in detail herein with reference to FIG. 3, the library UI 302 displays graphical representations 310 of respective skills that are available in the library 204 (e.g., responsive to a search request).

User selection of one or more skills is received (406). For example, and as described in detail herein, the user can select a skill for inclusion in a task (e.g., an order approval task) by, for example, a drag-and-drop interaction on a graphical representation 312 of a skill artifact within a project-specific UI 304. One or more mappings are provided (408). For example, and as described in detail herein, for each skill selected by the user, the user can configure properties of the skill. For example, the user can select the skill within the project-specific UI 304 (e.g., double-clicking on the graphical representation 312), and, in response, a mapping interface 314 can be displayed in the project-specific UI 304. In some examples, the manifest file of the skill (e.g., the example of Listing 1) is read to determine the input/output/error signature and provide mapping fields within the mapping interface 314, through which the user can provide input to define a mapping for the skill. For example, and with reference to the example of Listing 1, the skill can include a product recommendation and the mapping 314 is populated with input fields (e.g., to be displayed in a UI during runtime) to receive input of name and content type and output fields to display output (results) of invocation of the skill. In this example, output can include one or more products and, for each product, description, price, review count, and review score.

The application is deployed for runtime (410). For example, and as described in detail herein, after the user has completed development of the application within the application development environment 202, computer-executable code (e.g., binary code) is generated (e.g., by compiling source code provided during development) and can be stored in the data store 212. In some examples, the computer-executable code include one or more code snippets that are executable during runtime to invoke a respective skill.

The application is executed (412). For example, and as described in detail herein, the application (e.g., the binary code) is deployed to the runtime environment 230 for execution by the LCNC runtime 240. In some examples, the application is executed to enable one or more users to perform tasks as part of a workflow. In some examples, execution of the application can include receiving input from the user, providing output to the user, and exiting the application (e.g., upon completion of the workflow). It is determined whether a skill is to be invoked (414). If a skill is not to be invoked, the example process 400 loops back. For example, and as described in detail herein, user input can be received that indicates that a skill is to be invoked. As an example, and continuing with the non-limiting example above, it can be determined that the user has provided input to invoke a product recommendation skill. In some examples, the LCNC runtime 240 injects a HTTP connection to invoke a skill from the skill runtime 242 using a REST operation. If a skill is to be invoked a skill artifact is retrieved (416). For example, and as described in detail herein, the skill runtime 242 fetches a skill artifact 220 (skill artifact manifest) from the library 204 for the skill that is invoked. In some examples, invocation of the skill includes a skill identifier (e.g., skillId) that uniquely identifies the skill being invoked and the skill runtime 242 retrieves the skill artifact from the library 204 using the skill identifier.

A request is transmitted to a service (418). For example, and as described in detail herein, the skill runtime 242 parses skill metadata within the skill artifact (e.g., using a JSON parser). In some examples, static values in skill metadata are determined, the static values having been provided during design-time. For example, and with reference to Listing 1, input values, output values, and error values are provided at design-time. The static values are read by the parser of the skill runtime 242. Using the resolved information, the skill runtime 242 executes skill invocation calls to a respective service hosted by the application server 208.

A response is received from the service (420). For example, and with continued reference to the non-limiting example, the service can be the product recommendation service that is invoked. In some examples, the skill runtime 242 outputs a result of the skill invocation, which can be used for one or more (downstream) tasks (e.g., display to a user). For example, and with reference to Listing 1, skill invocation can result in a data object (e.g., JSON object) that contains product review count, review scores, product images, product descriptions, and the like. The result of the skill invocation is resolved and returned to the LCNC runtime 240 (e.g., using HTTP). Output is provided to the application (422) and the example process 400 loops back. For example, and as described in detail herein, the LCNC runtime 240 can display the output of the skill invocation to the user in one or more UIs.

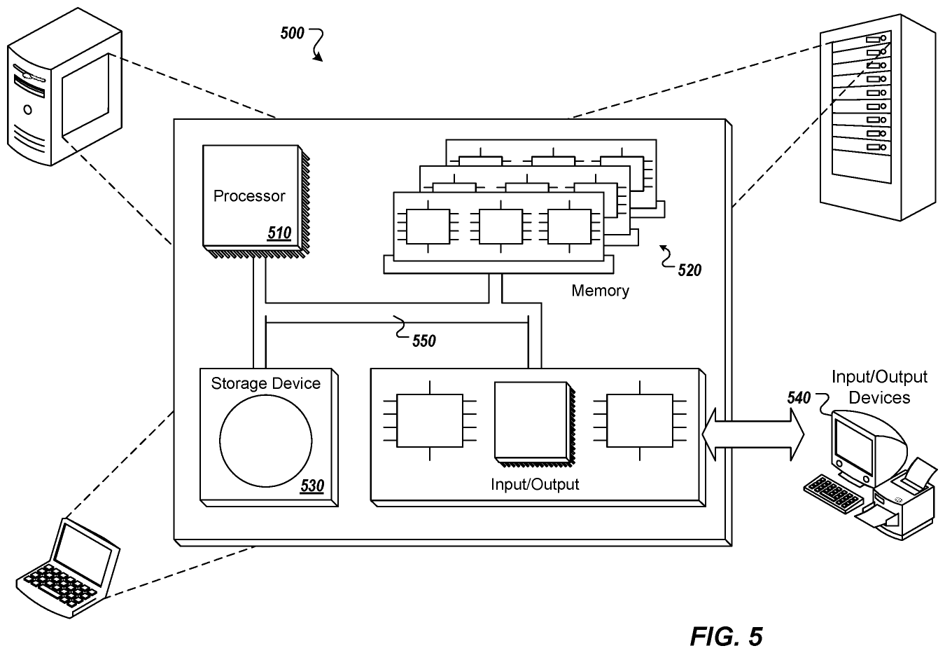

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for integrating skills into computer-executable applications, the method being executed by one or more processors and comprising:
receiving, during a design-time and by an application development platform, user input representative of a skill for invocation during runtime execution of an application, the skill being associated with a skill artifact that is stored in a library of skill artifacts;
providing, by the application development platform, the application as computer-executable code comprising a code snippet that is selectively executable to invoke the skill during runtime execution of the application; and
during runtime execution of the application, receiving, by an application runtime, user input representative of invocation of the skill, and in response:
retrieving, by a skill runtime that communicates with the application runtime, the skill artifact associated with the skill,
transmitting, by the skill runtime, a request to a service for execution of the skill, the request comprising input data comprising one or more of data input by a user during runtime execution of the application and data provided in the skill artifact,
receiving, by the skill runtime, a response from the service, and
providing, by the skill runtime and to the application runtime, the response to display at least a portion of the response to the user.

2. The method of claim 1, wherein the skill artifact defines a set of inputs representing the input data, the input data being required to execute functionality of the skill by the service, and a set of outputs representing output data that is to be provided by the service in the response.

3. The method of claim 1, wherein the response received from the service comprises a data object storing data determined during execution of functionality of the skill by the service.

4. The method of claim 1, wherein the user input representative of a skill for invocation during runtime execution of an application comprises a drag-and-drop input to a graphical representation of the skill provided by the application development platform.

5. The method of claim 1, further comprising parsing, by the skill runtime, at least a portion of the skill artifact to generate the request.

6. The method of claim 1, wherein the request is transmitted by the skill runtime to the service through an application programming interface (API) of the service.

7. The method of claim 1, wherein the application runtime and the skill runtime communicate through a hypertext transfer protocol (HTTP) connection.

8. A non-transitory computer-readable storage medium coupled to one or more processors and having instructions stored thereon which, when executed by the one or more processors, cause the one or more processors to perform operations for integrating skills into computer-executable applications, the operations comprising:
receiving, during a design-time and by an application development platform, user input representative of a skill for invocation during runtime execution of an application, the skill being associated with a skill artifact that is stored in a library of skill artifacts;
providing, by the application development platform, the application as computer-executable code comprising a code snippet that is selectively executable to invoke the skill during runtime execution of the application; and
during runtime execution of the application, receiving, by an application runtime, user input representative of invocation of the skill, and in response:
retrieving, by a skill runtime that communicates with the application runtime, the skill artifact associated with the skill,
transmitting, by the skill runtime, a request to a service for execution of the skill, the request comprising input data comprising one or more of data input by a user during runtime execution of the application and data provided in the skill artifact,
receiving, by the skill runtime, a response from the service, and
providing, by the skill runtime and to the application runtime, the response to display at least a portion of the response to the user.

9. The non-transitory computer-readable storage medium of claim 8, wherein the skill artifact defines a set of inputs representing the input data, the input data being required to execute functionality of the skill by the service, and a set of outputs representing output data that is to be provided by the service in the response.

10. The non-transitory computer-readable storage medium of claim 8, wherein the response received from the service comprises a data object storing data determined during execution of functionality of the skill by the service.

11. The non-transitory computer-readable storage medium of claim 8, wherein the user input representative of a skill for invocation during runtime execution of an application comprises a drag-and-drop input to a graphical representation of the skill provided by the application development platform.

12. The non-transitory computer-readable storage medium of claim 8, wherein operations further comprise parsing, by the skill runtime, at least a portion of the skill artifact to generate the request.

13. The non-transitory computer-readable storage medium of claim 8, wherein the request is transmitted by the skill runtime to the service through an application programming interface (API) of the service.

14. The non-transitory computer-readable storage medium of claim 8, wherein the application runtime and the skill runtime communicate through a hypertext transfer protocol (HTTP) connection.

15. A system, comprising:
a computing device; and
a computer-readable storage device coupled to the computing device and having instructions stored thereon which, when executed by the computing device, cause the computing device to perform operations for integrating skills into computer-executable applications, the operations comprising:
receiving, during a design-time and by an application development platform, user input representative of a skill for invocation during runtime execution of an application, the skill being associated with a skill artifact that is stored in a library of skill artifacts;
providing, by the application development platform, the application as computer-executable code comprising a code snippet that is selectively executable to invoke the skill during runtime execution of the application; and
during runtime execution of the application, receiving, by an application runtime, user input representative of invocation of the skill, and in response:
retrieving, by a skill runtime that communicates with the application runtime, the skill artifact associated with the skill,
transmitting, by the skill runtime, a request to a service for execution of the skill, the request comprising input data comprising one or more of data input by a user during runtime execution of the application and data provided in the skill artifact,
receiving, by the skill runtime, a response from the service, and
providing, by the skill runtime and to the application runtime, the response to display at least a portion of the response to the user.

16. The system of claim 15, wherein the skill artifact defines a set of inputs representing the input data, the input data being required to execute functionality of the skill by the service, and a set of outputs representing output data that is to be provided by the service in the response.

17. The system of claim 15, wherein the response received from the service comprises a data object storing data determined during execution of functionality of the skill by the service.

18. The system of claim 15, wherein the user input representative of a skill for invocation during runtime execution of an application comprises a drag-and-drop input to a graphical representation of the skill provided by the application development platform.

19. The system of claim 15, wherein operations further comprise parsing, by the skill runtime, at least a portion of the skill artifact to generate the request.

20. The system of claim 15, wherein the request is transmitted by the skill runtime to the service through an application programming interface (API) of the service.
